(19) United States
(12) Patent Application Publication
(10) Pub. No.: US 2021/0097674 A1
(43) Pub. Date: Apr. 1, 2021

(54) SYSTEM FOR IDENTIFYING AND CORRECTING IRREGULARITIES OF THE SURFACES OF AN OBJECT

(71) Applicant: Ford Global Technologies, LLC, Dearborn, MI (US)

(72) Inventors: Hossein Jacob Sadri, Novi, MI (US); Steve Juszczyk, Walled Lake, MI (US); Steven Torey, Macomb Township, MI (US); Lance David Marsac, South Lyon, MI (US)

(73) Assignee: Ford Global Technologies, LLC, Dearborn, MI (US)

(21) Appl. No.: 16/585,733

(22) Filed: Sep. 27, 2019

(51) Int. Cl. G06T 7/00; B25J 9/16; G05B 19/4097; G05B 19/18

(52) U.S. Cl. CPC G06T 7/0008; B25J 9/1697; G05B 19/4097; G05B 2219/45066; G06T 2207/30156; G05B 2219/37113; G05B 19/182

(57) ABSTRACT

An inspection station identifies irregularities of surfaces of an object and a finishing station corrects irregularities identified. The inspection station includes a plurality of cameras configured to detect the irregularities under a light having a wavelength of ≥ about 380 nm to ≤ about 740 nm. The finishing station includes at least one robot, and the robot includes a light source configured to emit light having a wavelength of ≥ about 380 nm to ≤ about 740 nm, a camera, and an abrasive tool for correcting detected irregularities of the surfaces of the object.

### FIELD

The present disclosure relates to objectively identifying and correcting surface irregularities in objects, and more particularly, in body-in-white and vehicle-on-wheel surfaces.

### BACKGROUND

The statements in this section merely provide background information related to the present disclosure and may not constitute prior art.

Galvanizing steel, which generally involves applying a thin coating of zinc to the steel to protect against corrosion, offers a wide array of advantages for use in body-in-white (“BIW”) and vehicle-on-wheel (“VOW”) applications. More specifically, galvanized steel has a low initial cost, provides a sacrificial coating, is resistant to damage, and increases durability while offering lower maintenance costs over non-galvanized steel. Galvanizing BIW and VOW surfaces is resultantly prevalent in the automotive industry. After galvanization, irregularities are subjectively identified (e.g., by eye or touch) and perceived irregularities are then corrected.

And in general, carbon fibers and alloys such as steel, nickel alloys, aluminum alloys, also have their surfaces subjectively identified for irregularities, which are then corrected when an irregularity is identified. These issues related to identifying and accurately correcting surface irregularities in surfaces of an object are addressed by the present disclosure.

### SUMMARY

According to one form of the present disclosure, a system for detecting and correcting at least one irregularity of at least one surface of an object includes a conveyor configured to transport an object through an inspection station and a finishing station. The inspection station includes a plurality of cameras configured to detect at least an irregularity of the surfaces of the object, and the plurality of cameras photograph the surfaces of the objects under a light having a wavelength of greater than or equal to about 380 nm to less than or equal to about 740 nm. The finishing station includes a robot, and the robot includes a light source configured to emit a light having a wavelength of greater than or equal to about 400 nm to less than or equal to about 565 nm, a camera, and an abrasive tool configured to correct any detected irregularity.

In a variation, the plurality of cameras photograph the surface under a light having a wavelength of greater than or equal to about 520 nm to less than or equal to about 560 nm. In yet other such variations, the light source of the robot is configured to emit a light having a wavelength of greater than or equal to about 520 nm to less than or equal to about 560 nm.

In a further variation, a tool station is positioned adjacent to the robot.

In another variation, the object is transported through the inspection station at a substantially constant speed. In other such variations, the object is transported through the finishing station at a substantially constant speed.

In yet another variation, the finishing station further comprises a display configured to display any detected irregularity of.

According to another form, a method for detecting and correcting at least one irregularity of at least one surface of an object includes photographing the surfaces of the object under a light having a wavelength of greater than or equal to about 400 nm to less than or equal to about 565 nm to detect the irregularity while the object is transported through an inspection station. Corresponding coordinates of any irregularity detected are mapped to a set of coordinates corresponding to the object. Any detected irregularity are corrected in a finishing station by applying an abrasive tool to a location specified by the mapped corresponding coordinates.

In a variation, after correcting any irregularity, the irregularity corrected is illuminated at a wavelength of greater than or equal to about 400 nm to less than or equal to about 565 nm.

In another variation, the light has a wavelength of greater than or equal to about 520 nm to less than or equal to about 560. In other such variations, after correcting any irregularity, the irregularity corrected is illuminated at a wavelength of greater than or equal to about 400 nm to less than or equal to about 565 nm.

In a further variation, the location specified by the mapped corresponding coordinates is displayed.

In yet a further variation, the object is transported through the inspection station at a substantially constant speed. In other such variations, the object is transported through the finishing station at a substantially constant speed.

According to a further form, a method for detecting and correcting at least one irregularity of at least one surface of an object includes identifying any irregularity while the object is transported through an inspection station by photographing the at least one surface of the object to be corrected under a light having a wavelength of greater than or equal to about 400 nm to less than or equal to about 565 nm. Any irregularity detected is displayed. Any irregularity is corrected in a finishing station by applying an abrasive tool to a location corresponding to the area on the object where the irregularity detected is displayed.

In a variation, after correcting any irregularities, the area corresponding to the detected irregularity is illuminated at a wavelength of greater than or equal to about 400 nm to less than or equal to about 565 nm.

In another variation, the light has a wavelength of greater than or equal to about 520 nm to less than or equal to about 560 nm. In other such variations, after correcting any irregularity detected, the area corresponding to the detected irregularity is illuminated at a wavelength of greater than or equal to about 520 nm to less than or equal to about 560 nm.

In a further variation, the object is transported through the inspection station at a substantially constant speed. In other such variations, the object is transported through the finishing station at a substantially constant speed.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic representation of a body-in-white according to the prior art;

FIG. 2 is a front view of an inspection station according to the teachings of the present disclosure;

FIG. 3 is a schematic view of a coordinate system used in accordance with the teachings of the present disclosure;

FIG. 4 is a front view of a finishing station configured in accordance with the teachings of the present disclosure; and

FIG. 5 is flowchart of a process for identifying and correcting an irregularity according to the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

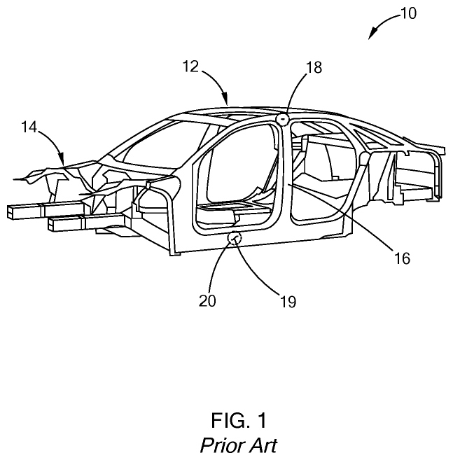

Referring to FIG. 1, a representative object 10, which is specifically illustrated as a vehicle body-in-white (“BIW”), is illustrated. The object 10 specifically illustrates a roof rail 12, a front rail 14, various pillars 16, and surfaces 18, 20 discussed in greater detail below. It should be understood, however, that the components of the object 10 in FIG. 1 should not be construed as limited to the specific components depicted. As non-limiting examples, the object 10 may also include a hood, a roof panel, additional roof rails, additional pillars (such as A-pillars, B-pillars, C-pillars, D-pillars, etc.), side rails, a front bumper, a rear bumper, a front fender, a rear fender, additional front rails, rear rails, rocker panels, struts, shock towers, cross members, floor panels, supports, or any other component of a BIW, vehicle body structure, or any of a variety of physical structures, and not limited to vehicles as described herein. Furthermore, the scope of the disclosure extends beyond what is shown specifically and may also be representative of any type of vehicle including, but not limited to, compact cars, trucks, sedans, sport-utility vehicles, etc. The object 10 may comprise a galvanized surface, an alloy, such as steel, nickel alloys, aluminum alloys, and the like.

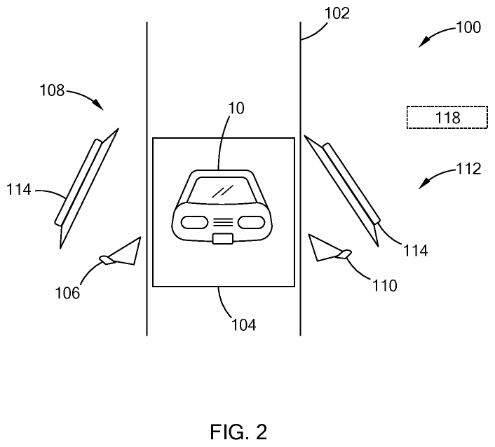

Referring to FIG. 2, an inspection station 100 is illustrated. The inspection station includes a conveyor 102 or other conveyance system that is configured to transport the object 10 through the inspection station 100. A conveying platform 104 is configured to position the object while being transported through the inspection station 100. The conveyor 102 may be configured to continuously transport the conveying platform 104 and the object 10 through the inspection station 100 at a substantially constant speed with or without stopping in the inspection station 100.

The inspection station 100 further includes at least one camera 106 having at least a light source positioned on a first side 108 of the inspection station 100 and at least one other camera 110 having at least a light source positioned on a second side 112 of the inspection station 100. The light sources of the cameras 106 and 110 emit a light having a wavelength of greater than or equal to about 400 nm to less than or equal to about 565 nm. According to a variation, the light sources of the cameras 106 and 110 emit a light having a wavelength of greater than or equal to about 380 nm to less than or equal to about 740 nm. According to a variation, the light sources of the cameras 106 and 110 emit a light having a wavelength of greater than or equal to about 520 nm to less than or equal to about 560 nm (i.e., green light). The cameras 106 and 110 are configured to capture images of the surfaces or portions of surfaces (referred to herein simply as “surfaces”) of the object 10 while the light sources are directing light to the surfaces, such as surfaces 18, 20, shown in FIG. 1, of the object 10. While the surfaces 18, 20 are shown on the body frame (not labeled) of the object 10 in FIG. 1, it should be understood that that the surfaces 10 can be on other areas, sections or components of a BIW including, but not limited to, surfaces of fender panels, door panels, a hood, a trunk lid, and a roof, among others.

Any camera(s) that is capable of capturing images of surfaces while the object 10 is illuminated under the aforementioned wavelengths is suitable such as the cameras 106 and 110. Exemplary cameras include image colorimeters and photometers, commercially available from Radiant Vision Systems, LLC. The cameras 106 and 110 are movable (in rotation and translation, with an unlimited number of degrees of freedom (DOF)) such that all features, including corners, pockets or recesses, curved surfaces, flat surfaces, and all surface profile geometries, of the object 10 can be captured. In a variation, the camera 106 can be secured to a movable robot or robot arm to allow the camera 106 to more accurately and comprehensively capture all of the surfaces of the object 10. In a variation, multiple cameras work together to capture all of the surfaces of the object 10 and each can be secured to a respective robot or robot arm.

In a variation, at least a ceiling light 114 is positioned in the inspection station 100 to provide additional light as necessary to illuminate the surfaces for the cameras 106/110. Any ceiling lights, such as the ceiling light 114, may emit light at a wavelength at or substantially similar to the wavelength of the sources of light emitted by the cameras to provide additional light if warranted.

In a variation, the cameras (such as cameras 106 and 110) are configured to detect light from the light sources reflected and/or refracted from the surfaces of the object, e.g., by emitting electromagnetic waves that interact with the surfaces of the object 10. Based on these reflections or refractions of the light and the refractive index of the surfaces of the object 10, the camera 106 and 110 can detect surface irregularities on the surfaces of the object 10 and capture images of the detected surface irregularities. One example of a surface irregularity is scratch 19 (FIG. 1). Other non-limiting examples of surface irregularities include dimples, splotches and excess or wrinkled coating material, among others.

As described in greater detail below, the cameras (such as cameras 106 and 110) may be configured to communicate the associated coordinates of the irregularities detected on surfaces of the object 10 relative to a coordinate system to a controller 118, where images captured showing irregularities are shown on a display.

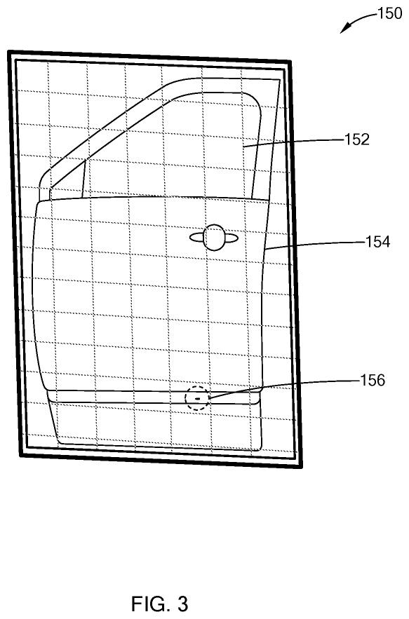

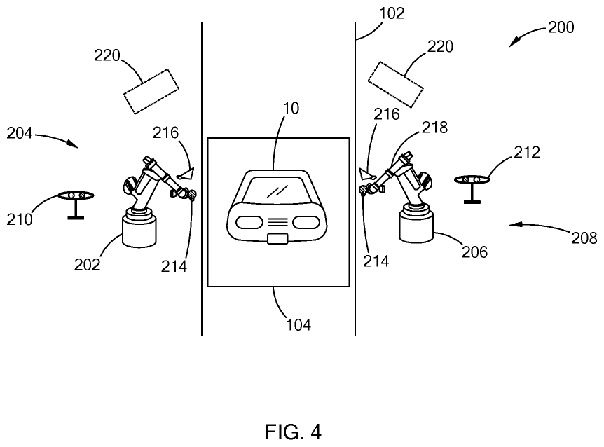

Referring to FIG. 3, a coordinate system 150 is displayed such that an image captured by the cameras depicting an irregularity can be displayed relative to the coordinate system 150. The coordinate system 150 can be displayed as a grid, array, or the like, to make it easier for identifying the precise location of the irregularity detected by any of the cameras. The coordinate system 150, shown as a grid 152 overlaying an image of a door panel 154 is illustrated. While a two-dimensional grid 152 and door panel 154 is illustrated in FIG. 3, it is contemplated three-dimensional models may also be illustrated. Coordinates corresponding to an irregularity 156 can be mapped to a set of coordinates corresponding to the door panel 154. In one variation the location of the irregularity 156 can be directly mapped to a 3D CAD (computer aided design) model of the door panel 154 for proper location. Accordingly, the coordinate system 150 allows identification of the location where an irregularity 156 has been identified by any of the cameras so that the irregularity 156 can be quickly and conveniently addressed. For example, and as described below, the irregularity 156 can be corrected by applying an abrasive to a location specified by the mapped corresponding coordinates. Referring to FIG. 4, the object 10 continues to traverse via the conveyor 102 to a finishing station 200. The conveyor 102 may be configured to continuously transport the conveying platform 104 and the object 10 through the finishing station 200 at a substantially constant speed with or without stopping in the finishing station 200. The finishing station 200 includes at least a movable first robot 202 on a first side 204 of the finishing station 200 and at least a movable second robot 206 on a second side 208 of the finishing station 200. The finishing station 200 further includes a first tool station 210 adjacent to the first robot 202 and a second tool station 212 adjacent to the second robot 206. Any tool stations (such as the first tool station 210 and the second tool station 212) have tools, such as sandpaper, polishing stones, grinder pads, grinder stones, and buffing stones, among others, that are appropriate for correcting irregularities of the surfaces of the object 10 that are identified. The tools may be tailored to the makeup of the object 10. For example, a different abrasive tool may operate to correct an irregularity when the object 10 comprises an aluminum alloy, as opposed to steel.

Each of the robots (such as the first robot 202 and the second robot 206) includes an abrasive tool 214 and a light source 216. The light source 216 includes a camera, and any camera that is capable of capturing images of surfaces while the object 10 is illuminated under the wavelengths described below is suitable as the camera of the light source 216. Exemplary cameras include image colorimeters and photometers, commercially available from Radiant Vision Systems, LLC. The light source 216 is configured to emit a light having a wavelength of greater than or equal to about 400 nm to less than or equal to about 565 nm. According to a variation, the light source 216 emits a light having a wavelength of greater than or equal to about 380 nm to less than or equal to about 740 nm. According to a variation, the light source 216 is configured to emit a light having a wavelength of greater than or equal to about 520 nm to less than or equal to about 560 nm. The robots 202, 206 move such that the abrasive tools 214 can reach the surfaces of the object 10 and a respective tool station 210, 212. The robots 202, 206 are also movable such that the light sources 216 can illuminate the surfaces of the object 10. According to a variation, the abrasive tools 214 and the light sources 216 may reside on a single arm of each robot 202, 206, such as a robot arm 218. According to another variation, the abrasive tools 214 and the light sources 216 may reside on separate arms of a respective robots 202, 206.

According to a variation, the finishing station includes at least one display 220 for displaying any irregularity identified. The display 220 may display the irregularity in a grid like manner, such as shown in FIG. 3. According to a variation, the display 220 displays a close-up view of the irregularity. While the display is shown located within the finishing station 200, it is contemplated the display 220 could be located remotely from the finishing station 200.

In operation, in the finishing station 200, a robot (such as the first robot 202) identifies and selects an abrasive, such as sandpaper, polishing stones, grinder pads, grinder stones, and buffing stones, among others, for attachment to the abrasive tool 214 from a respective tool station (such as the first tool station 212) that is tailored to correct the irregularity detected. The robot then moves the abrasive tool 214 to the irregularity of the surface of the object 10, applies a predetermined force to the surface via the abrasive tool 214, and abrades the irregularity for a predetermined amount of time (referred to herein as a “first abrasion”). While the robot abrades the irregularity, the light source 216 illuminates the irregularity and captures photographs of the irregularity. The captured photos are visually inspected by an operator or data corresponding to the captured photos are digitally analyzed to determine whether irregularities are visible, and, if so, whether further abrasion is warranted. If not, the robot again applies the abrasive tool 214 to the irregularity at a predetermined force for a predetermined amount of time (referred to herein as a “second abrasion”). The force and time in the second abrasion may be the same or different from the first abrasion, depending on the changing nature of the irregularity detected after the initial abrasion. If warranted, a third abrasion, a fourth abrasion, and additional abrasions, may occur. If, after a predetermined number of attempts at correcting the irregularity do not satisfactorily correct the irregularity, the object 10 may exit the production cycle for further processing.

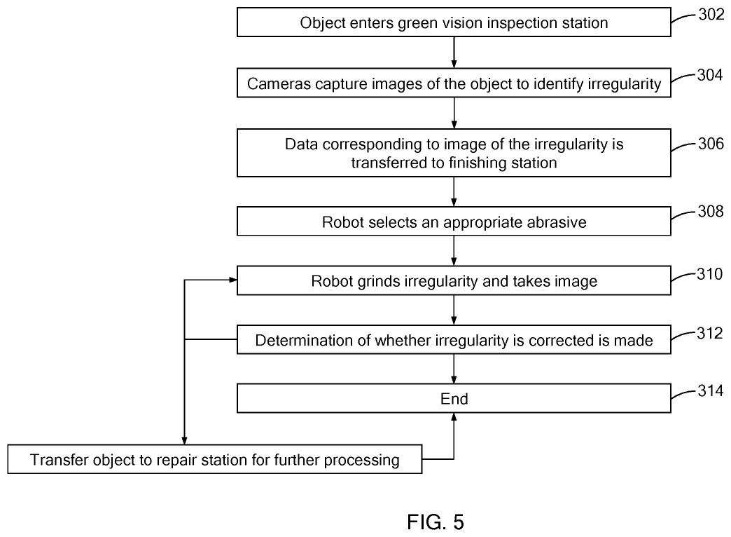

Referring to FIG. 5, a flowchart of a method 300 for identifying and correcting an irregularity according to the present disclosure is provided. At 302, an object (such as the object 10) enters an inspection station (such as the inspection station 100). At 304, a plurality of cameras (such as the cameras 106 and 110) capture images correlating to all of the surfaces of the object under a light at a wavelength of greater than or equal to about 400 nm to less than or equal to about 565 nm. According to a variation, at 304, a plurality of cameras (such as cameras 106 and 110) capture images corresponding to all of the surfaces of the object under a light at a wavelength of greater than or equal to about 520 nm to less than or equal to about 560 nm. At 306, data corresponding to the images taken by the plurality of cameras is transferred to a finishing station (such as the finishing station 200). The data is transferred to at least a robot (such as the first robot 202) and provides a location on a surface where an irregularity was identified in the inspection station. At 308, the robot selects an appropriate abrasive for correcting the irregularity and attaches the abrasive to its abrasive tool (such as abrasive tool 214). At 310, the robot grinds the irregularity with the abrasive, removes the abrasive away from the irregularity, and illuminates the area where the irregularity was identified at a wavelength of greater than or equal to about 400 nm to less than or equal to about 565 nm. According to a variation, the illumination occurs at a wavelength of greater than or equal to about 520 nm to less than or equal to about 560 nm. An image is captured to determine whether the irregularity was corrected. At 312, whether or not the irregularity was corrected is determined and if not, the method 300 reverts to 310. If it is determined the irregularity was corrected at 312, the object leaves the finishing station and the routine ends at 314. And if, after a predetermined number of reversions to 310, the irregularity remains uncorrected, the routine proceeds to 316, where the object is sent to a repair station for further processing, at which time the routine ends at 314.

According to a variation, the frequency of irregularities may be logged into a database. In this fashion, it can be determined how often a particular source delivers objects having irregularities.

According to a variation, the program controlling the behavior of any robot (such as the first robot 202) can be overwritten with a new or supplemental program to meet any particular demand.

Although the terms first, second, third, etc. may be used to describe various elements, components, regions, layers and/or sections, these elements, components, regions, layers and/or sections, should not be limited by these terms. These terms may be only used to distinguish one element, component, region, layer and/or section, from another element, component, region, layer and/or section. Terms such as “first,” “second,” and other numerical terms when used herein do not imply a sequence or order unless clearly indicated by the context. Thus, a first element, component, region, layer or section, could be termed a second element, component, region, layer or section without departing from the teachings of the example forms. Furthermore, an element, component, region, layer or section may be termed a “second” element, component, region, layer or section, without the need for an element, component, region, layer or section termed a “first” element, component, region, layer or section.

Spacially relative terms, such as “inner,” “outer,” “beneath,” “below,” “lower,” “above,” “upper,” “adjacent,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above or below. The device may be otherwise oriented (rotated 90 degrees or at other orientations) and the spatially relative descriptors used herein interpreted accordingly.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice; material, manufacturing, and assembly tolerances; and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The terminology used herein is for the purpose of describing particular example forms only and is not intended to be limiting. The singular forms “a,” “an,” and “the” may be intended to include the plural forms as well, unless the context clearly indicates otherwise. The terms “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A system for detecting and correcting at least one irregularity of at least one surface of an object, the system comprising:
an inspection station comprising a plurality of cameras configured to detect an irregularity, wherein the plurality of cameras photograph the surfaces of the object under a light having a wavelength of greater than or equal to about 400 nm to less than or equal to about 565 nm;
a finishing station comprising a robot, wherein the robot comprises a light source configured to emit light having a wavelength of greater than or equal to about 400 nm to less than or equal to about 565 nm, a camera, and an abrasive tool configured to correct the detected irregularity; and
a conveyor configured to transport the object through the inspection station and the finishing station.

2. The system according to claim 1, wherein the plurality of cameras photograph the at least one surface under a light having a wavelength of greater than or equal to about 520 nm to less than or equal to about 560 nm.

3. The system according to claim 2, wherein the robot comprises a light source configured to emit light having a wavelength of greater than or equal to about 520 nm to less than or equal to about 560 nm.

4. The system according to claim 1, further comprising a tool station positioned adjacent to the robot.

5. The system according to claim 1, wherein the object is transported through the inspection station at a substantially constant speed.

6. The system according to claim 5, wherein the object is transported through the finishing station at a substantially constant speed.

7. The system according to claim 1, wherein the finishing station further comprises a display configured to display the irregularity.

8. A method for detecting and correcting at least one irregularity of at least one surface of an object, the method comprising:
photographing the at least one surface of the object under a light having a wavelength of greater than or equal to about 400 nm to less than or equal to about 565 nm to detect the at least one irregularity while the object is transported through an inspection station;
mapping corresponding coordinates of the at least one irregularity detected into a set of coordinates corresponding to the object;
correcting the at least one irregularity detected in a finishing station by applying an abrasive tool to a location specified by the mapped corresponding coordinates.

9. The method according to claim 8, further comprising, after correcting the at least one irregularity, illuminating the at least one irregularity at a wavelength of greater than or equal to about 400 nm to less than or equal to about 565 nm.

10. The method according to claim 8, wherein the light has a wavelength of greater than or equal to about 520 nm to less than or equal to about 560 nm.

11. The method according to claim 10, further comprising, after correcting the at least one irregularity, illuminating the at least one irregularity at a wavelength of greater than or equal to about 520 nm to less than or equal to about 560 nm.

12. The method according to claim 8, further comprising displaying a location specified by the mapped corresponding coordinates.

13. The method according to claim 8, further comprising transporting the object through the inspection station at a substantially constant speed.

14. The method according to claim 13, further comprising transporting the object through the finishing station at a substantially constant speed.

15. A method for detecting and correcting at least one irregularity of at least one surface of an object, the method comprising:
identifying an irregularity while the object is transported through an inspection station by photographing the at least one surface of the object under a light having a wavelength of greater than or equal to about 400 nm to less than or equal to about 565 nm;
displaying the irregularity detected;
correcting the irregularity detected in a finishing station by applying an abrasive tool to a location corresponding to the area on the object where the irregularity detected are displayed.

16. The method according to claim 15, further comprising, after correcting the irregularity detected, illuminating the irregularity at a wavelength of greater than or equal to about 400 nm to less than or equal to about 565 nm.

17. The method according claim 15, wherein the light has a wavelength of greater than or equal to about 520 nm to less than or equal to about 560 nm.

18. The method according to claim 17, further comprising, after correcting the irregularity detected, illuminating the irregularity at a wavelength of greater than or equal to about 520 nm to less than or equal to about 560 nm.

19. The method according to claim 15, further comprising transporting the object through the inspection station at a substantially constant speed.

20. The method according to claim 19, further comprising transporting the object through the finishing station at a substantially constant speed.
